(19) United States
(12) Patent Application Publication
(10) Pub. No.: US 2019/0294643 A1
(43) Pub. Date: Sep. 26, 2019

(54) GPU-BASED METHOD FOR OPTIMIZING RICH METADATA MANAGEMENT AND SYSTEM THEREOF

(71) Applicant: Huazhong University of Science and Technology, Wuhan (CN)

(72) Inventors: Xuanhua Shi, Wuhan (CN); Hai Jin, Wuhan (CN); Wenke Li, Wuhan (CN); Ying Yang, Wuhan (CN); Wei Liu, Wuhan (CN)

(21) Appl. No.: 16/284,611

(22) Filed: Feb. 25, 2019

(30) Foreign Application Priority Data
Mar. 21, 2018 (CN) 201810238040.8

(51) Int. Cl. G06F 16/953; G06F 9/50; G06F 16/901

(52) U.S. Cl. CPC G06F 16/953; G06F 16/9024; G06F 9/5016

(57) ABSTRACT

A GPU-based system for optimizing rich metadata management and a method thereof are disclosed. The system includes: a search engine for converting rich metadata information into traversal information and/or search information of a property graph, and providing at least one API according to a traversal process and/or a search process; a mapping module for detecting relationships among entity nodes in the property graph by means of mapping; a management module for activating a GPU thread group and allotting video memory blocks, so as to store the property graph in a GPU as a mixed graph; and a traversal module for activating a traversal program and performing detection and gathering on stored property arrays for iteration, so as to feed back a result of the iteration to the search engine. The system and the method are efficient in rich metadata search while having good scalability and compatibility.

### FIELD

The present invention relates to HPC (high performance computing) storage systems, and more particularly to a GPU-based (graphic processing unit) method for optimizing rich metadata management and a system thereof.

### DESCRIPTION OF THE RELATED ART

Graph structures have been applied in many fields to solve practical problems. For example, in a social network, individuals may be considered as entity vertexes, and relationships between individuals may be considered as edges, so as to achieve community detection and friend recommendation by means of graph management. A property graph includes a certain amount of properties on the basis of general graph structures, is capable of expressing richer relationships in the graph structures and is applied in more extensive fields.

Rich metadata is expansion of traditional metadata and expresses metadata relationships, environment variables and parameters and so on. Many use case scenarios of HPC (high performance computing) systems may be converted to management of rich metadata, such as user audit and provenance query. Rich metadata management is typically conducted through traversal and search of a property graph, wherein users, jobs and data files are defined as vertexes of the property graph, and their relationships are defined as edges of the property graph, while information describing the vertexes and the edges are defined as properties of the property graph. In this way, management of rich metadata can be transformed into traversal and search of a property graph.

The foregoing use case scenarios of HPC systems require effective rich metadata management, and thus need powerful computing capability and high bandwidth as supports. These requirements are demanding to CPUs (central processing units). Many graph algorithms, such as single-source shortest paths (SSSP) and breadth-first search (BFS), have been proven to have better performance when run in a GPU (graphic processing unit) than in a CPU (central processing unit). Transforming rich metadata management into traversal mode of property graphs is similar to BFS algorithm, wherein traversal is accompanied by filtering of property values.

### SUMMARY OF THE INVENTION

To address the shortcomings of the prior art, the present invention provides a GPU (graphic processing unit)-based system for optimizing rich metadata management, wherein the system at least comprises: a search engine for converting rich metadata information into traversal information and/or search information of a property graph, and providing at least one API (application programming interface) according to a traversal process and/or a search process; a mapping module for setting relationships among entity nodes in the property graph by mapping; a management module for activating a GPU thread group and allotting video memory blocks, so as to store the property graph in a GPU as a mixed graph; and a traversal module for activating a traversal program and performing iterative detection and gathering on stored property arrays for iteration, so as to feed back a result of the iteration to the search engine.

According to a preferred mode, the system further comprises a storage module, which stores the rich metadata information as arrays.

According to a preferred mode, the entity nodes of the property graph at least comprises a user, a job and/or a data file, each of edges of the property graph is the relationship between at least two entity nodes, properties in the property graph include properties of the entity nodes and properties of the relationships between the entity nodes.

According to a preferred mode, the mixed graph corresponding to the property graph includes graph architectures and SOAs (service oriented architectures), in which the graph architectures are stored in a CSR (control and status register) format; and the SOAs are stored as property arrays.

According to a preferred mode, the traversal module detects the property arrays by: determining whether properties of architecture of the property arrays satisfy filtering conditions, in which different properties are filtered linearly, and multiple filters constitute a combined filter.

According to a preferred mode, the traversal module gathers the property arrays by: gathering the entity nodes that satisfy the filtering conditions as data sets to receive the iteration, and performing the iteration on the data sets so as to form a frontier queue, in which the data sets include vertex sets and/or edge sets.

According to a preferred mode, when the iteration has not been completed, the traversal module takes the data sets of the frontier queue as initial data for a next round of the iteration, and when the iteration has been completed, the traversal module feeds back the frontier queue to the search engine.

According to a preferred mode, the mapping module and the management module work together in a complementary way to convert operational steps of management and search for the rich metadata into at least one array applicable to the traversal module, and the mapping module and the management module work together in a complementary way to conduct practical operation according to the property graph.

A GPU-based method for optimizing rich metadata management at least comprises: converting rich metadata information into traversal information and/or search information of a property graph, and providing at least one API (application programming interface) according to a traversal process and/or a search process; setting relationships among entity nodes in the property graph by mapping; activating a GPU thread group and allotting video memory blocks, so as to store the property graph in a GPU as a mixed graph; and activating a traversal program and performing detection and gathering on stored property arrays for iteration, and feeding back a result of the iteration to a search engine.

According to a preferred mode, the method further comprises: storing the rich metadata information as arrays.

According to a preferred mode, the entity nodes of the property graph in the method at least comprises a user, a job and/or a data file, wherein each of edges of the property graph is one said relationship between at least two said entity nodes, and properties in the property graph include properties of the entity nodes and properties of the relationships between the entity nodes.

According to a preferred mode, the mixed graph corresponding to the property graph includes graph architectures and SOAs, in which the graph architectures are stored in a CSR format; and the SOAs are stored as property arrays.

According to a preferred mode, the property arrays are detected by: determining whether properties of architecture of the property arrays satisfy filtering conditions, in which different properties are filtered linearly, and multiple filters constitute a combined filter.

According to a preferred mode, the property arrays are gathered by: gathering the entity nodes that satisfy the filtering conditions as data sets to receive the iteration, and performing the iteration on the data sets so as to form a frontier queue, in which the data sets include vertex sets and/or edge sets.

According to a preferred mode, the method further comprises: when the iteration has not been completed, the traversal module takes the data sets of the frontier queue as initial data for a next round of the iteration, and when the iteration has been completed, the traversal module feeds back the frontier queue to the search engine.

According to a preferred mode, the method further comprises: converting operational steps of management search for the rich metadata into at least one array applicable to the traversal module, and conducting practical operation according to the property graph.

The present invention further provides a GPU-based method for optimizing rich metadata management, wherein the method at least comprises: converting rich metadata information into traversal information and/or search information of a property graph, and providing at least one API according to a traversal process and/or a search process; setting relationships among entity nodes in the property graph by mapping; activating a GPU thread group and allotting video memory blocks, so as to store the property graph in a GPU as a mixed graph; and activating a traversal program and performing the detection stage and the gathering stage on stored property arrays for iteration, and feeding back a result of the iteration to a search engine, in which the detection stage and the gathering stage are jointly performed in the GPU in a convergent way.

The present invention further provides a GPU-based device for optimizing rich metadata management, which comprises a CPU processor and a GPU, wherein the CPU processor comprises a mapping module, a search engine and a management module, and the GPU comprises a traversal module and a storage module; the mapping module converts rich metadata information into a property graph. Edges of the property graph are relationships among users, jobs and data files as entity nodes of the property graph. Properties of the property graph include properties of the entity nodes and/or properties of the relationships among the three entity nodes; the search engine converts the rich metadata into traversal search information of the property graph according to the search information of the rich metadata by calling an API interface; the management module allots video memory of the storage module and sends the traversal search information to the traversal module; the traversal module detects and gathers the traversal search information of the property graph by means of iteration, and sends frontier queue data formed through the iteration to the search engine; the storage module stores the rich metadata information as arrays.

The present invention has the following beneficial technical effects:

(1) High efficiency in search of rich metadata: the present invention uses traversal of a property graph based on a GPU (graphic processing unit) to achieve management of rich metadata, wherein rich metadata management in the hybrid architecture of the CPU (central processing unit) and the GPU prevents the disadvantages of the CPU and leverages the advantages of the GPU in terms of high video memory bandwidth and high parallelization, so as to provide highly efficient management of rich metadata in applications such as user audit and provenance queries.
(2) Convenience in use: the present invention provides an API (application programming interface) of rich metadata management for HPC (high performance computing) systems, and this allows users and administrators to conveniently call a search interface for rich metadata management.
(3) Scalability and compatibility: the present invention well inherits good expandability from an HPC system, so that the disclosed method can be used whenever the HPC system needs unified management of metadata, thus having good compatibility.

### BRIEF DESCRIPTION OF THE DRAWINGS

FIG. 1 shows a schematic diagram of logic modules of a system of the present invention;

FIG. 2 is a schematic diagram of a property graph of the present invention stored as a mixed graph;

FIG. 3 illustrates iteration according to the present invention;

FIG. 4 is a schematic diagram illustrating detection filtering and gathering of vertexes during iteration according to the present invention; and

FIG. 5 is a schematic diagram illustrating detection filtering and gathering of edges during iteration according to the present invention.

### DETAILED DESCRIPTIONS OF THE INVENTION

The following description, in conjunction with the accompanying drawings and preferred embodiments, is set forth as below to illustrate the present invention.

It is noted that, for easy understanding, like features bear similar labels in the attached figures as much as possible.

As used throughout this application, the term “may” is of permitted meaning (i.e., possibly) but not compulsory meaning (i.e., essentially). Similarly, the terms “comprising”, “including” and “consisting” mean “comprising but not limited to”.

The phrases “at least one”, “one or more” and “and/or” are for open expression and shall cover both connected and separate operations. For example, each of “at least one of A, B and C”, “at least one of A, B or C”, “one or more of A, B and C”, “A, B or C” and “A, B and/or C” may refer to A solely, B solely, C solely, A and B, A and C, B and C or A, B and C.

The term “a” or “an” article refers to one or more articles. As such, the terms “a” (or “an”), “one or more” and “at least one” are interchangeable herein. It is also to be noted that the term “comprising”, “including” and “having” used herein are interchangeable.

As used herein, the term “automatic” and its variations refer to a process or operation that is done without physical, manual input. However, where the input is received before the process or operation is performed, the process or operation may be automatic, even if the process or operation is performed with physical or non-physical manual input. If such input affects how the process or operation is performed, the manual input is considered physical. Any manual input that enables performance of the process or operation is not considered “physical”.

### Embodiment 1

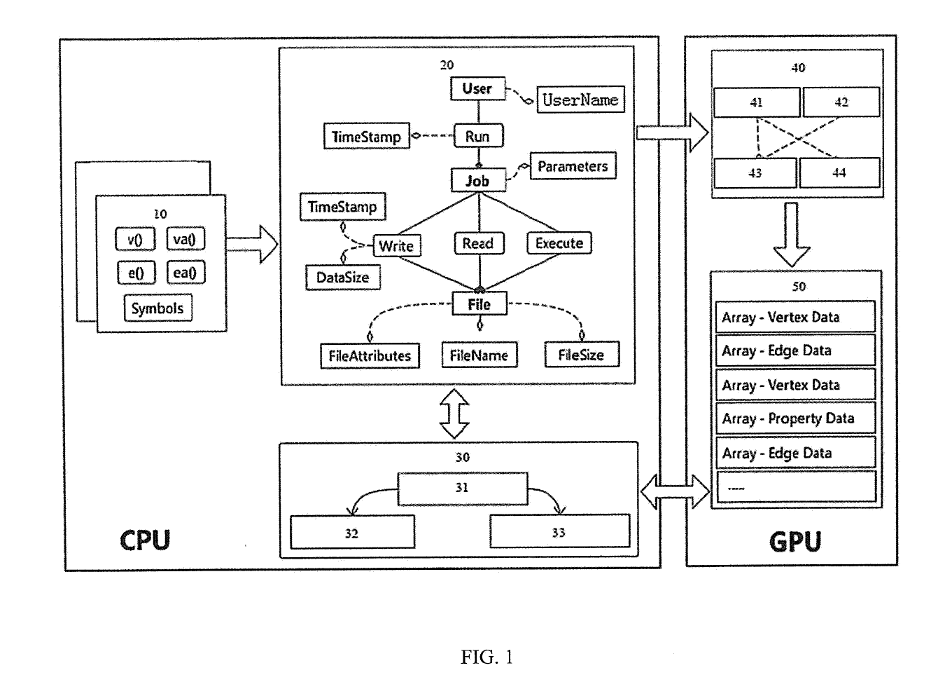

A GPU (graphic processing unit)-based method for optimizing rich metadata management. As shown in FIG. 1, a GPU-based system for optimizing rich metadata management of the present invention at least comprises: a search engine 10, a mapping module 20, a management module 30, and a traversal module 40. Preferably, the disclosed GPU-based system for optimizing rich metadata management further comprises a storage module 50.

The search engine 10 converts rich metadata information into traversal information and/or search information of a property graph, and provides at least one API (application programming interface) according to a traversal process and/or a search process. Specifically, the search engine 10 provides a search interface. Tasks like user audit and provenance checking in applications of rich metadata management are transformed into traversal and search of the property graph.

The mapping module 20 sets relationships among the entity nodes in the property graph by mapping. Preferably, the entity nodes of the property graph at least comprise a user, a job and/or a data file. Each of edges of the property graph is the relationship between at least two said entity nodes. Properties of the property graph include properties of the entity nodes and additional properties of the relationships between the entity nodes.

The management module 30 activates a GPU thread group and allots video memory blocks, so as to store the property graph in a GPU as a mixed graph.

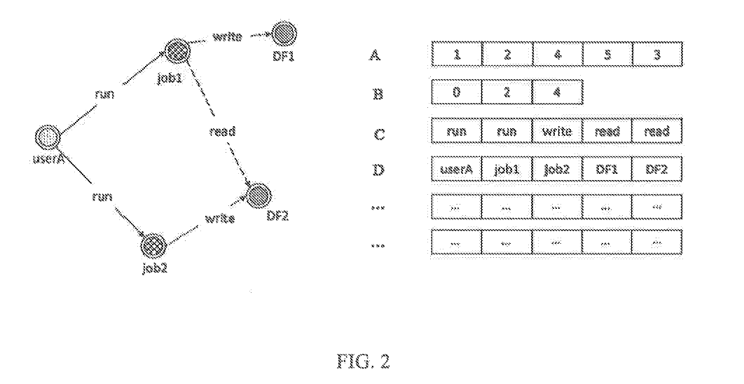

The property graph is architecturally different from a normal graph, and may be stored in the GPU in various ways. Preferably, as shown in FIG. 2, the mixed graph corresponding to the property graph includes graph architectures and SOAs (service oriented architectures). The graph architectures are stored in the format of CSR (control and status register). The SOAs are stored as property arrays. The entity nodes and relationships of the property graph are stored in the format of CSR, and particularly stored in the SOA of arrays. That is, the entity nodes and relationships are stored in the video memory in the GPU as plural arrays, acting as a data source for the traversal engine.

The traversal module 40 activates a traversal program and performs iterative detection and gathering on stored property arrays, so as to feed back a result of the iteration to the search engine.

Preferably, the traversal module detects the property arrays by: determining whether properties of architecture of the property arrays satisfy filtering conditions, in which different properties are filtered linearly, and multiple filters constitute a combined filter. For example, in traversal of every BFS (breadth first search), it performs detections on at least one property to determine whether the property satisfies the filtering conditions. Every time of detection is unique and has to be specified.

The traversal module gathers the property arrays by: gathering the entity nodes satisfying the filtering condition as data sets to receive iteration. The data sets are gathered into a frontier queue. The data sets include vertex sets and/or edge sets.

When the iteration has not been completed, the traversal module takes the data sets of the frontier queue as the initial data for the next round of iteration. When the iteration has been completed, the traversal module feeds back the frontier queue to the search engine.

Preferably, the mapping module 20 and the management module 30 work together in a complementary way to convert operational steps of management and search for the rich metadata into at least one array applicable to the traversal module 40. Then the mapping module 20 and the management module 30 work together in a complementary way to conduct practical operation according to the property graph.

Preferably, the disclosed system further comprises a storage module 50. The storage module 50 stores rich metadata information as arrays.

Preferably, the search engine 10 comprises one or more of a CPU (central processing unit) processor, an application specific integrated chip, a server, a cloud server, and a microprocessor. The mapping module 20 comprises one or more of a CPU processor, an application specific integrated chip, a server, a cloud server, and a microprocessor capable of data mapping.

As shown in FIG. 1, the management module 30 comprises a buffer management module 31, a data transmission module 32 and a storage allocator 33. The buffer management module 31 comprises one or more of a cache, a cache chip, and a cache processor. The data transmission module 32 comprises one or more of a communicator, a signal emitter, and a signal transmission chip for data transmission. The storage allocator 33 comprises one or more of an application specific integrated chip, a processor, a single-chip microcomputer, and a server for computation or allotting of the storage capacity.

Preferably, the traversal module 40 comprises an access module 41, a computing module 42, a detecting module 43 and a gathering module 44. Preferably, the access module 41 accesses the edges and/or vertexes of the graph, and the additional properties of the edges and/or vertexes. The access module 41 comprises one or more of a GPU, an application specific integrated chip, a server, and a microprocessor.

The computing module 42 conducts computation for property conditions and detection conditions. The computing module 42 comprises one or more of a GPU, an application specific integrated chip, a server, and a microprocessor.

The detecting module 43 detects and filters the entity nodes. The detecting module 43 comprises one or more of a GPU, an application specific integrated chip, a server, and a microprocessor. The gathering module 44 gathers the filtered entity nodes and forms the frontier queue. The detecting module 43 comprises one or more of a GPU, an application specific integrated chip, a server, and a microprocessor.

Preferably, the management module 30 uses the high bandwidth and efficient parallel-processing of the GPU to achieve efficient management of rich metadata. The disclosed system is a CPU-GPU hybrid. The CPU primarily manages the relationships among the vertexes and the relationships among the property arrays. It is the GPU that performs operations on the vertex arrays and property arrays, and the entire process is iterative.

Preferably, the entire iteration process is convergent. The frontier queue obtained after the filtering against the conditions is the final right result, which is to be returned to the search engine 10. The data for every iteration is independent, so the present invention can make good use of parallel computing of a GPU.

The operations of plural detecting stages may be combined in the GPU. The CPU activates an operational kernel every time of traversal for the GPU to process the arrays. All the operational kernels other than the last operational kernel generate intermediate results for the next operation. By combining plural operational kernels, redundant computation and storage as well as reading of the intermediate results can be reduced. The combination process of operations in a GPU is called as combination of basic operations.

A series of kernels corresponding to the property arrays of the rich metadata activate threads in the GPU, and the computations of mass data accesses and searches are completed in the GPU. The CPU manages the relationships between the rich metadata arrays, and uses its high bandwidth and computation capacity to parallelly read and process mass data. The CPU-GPU hybrid thereby achieves more efficient management of metadata.

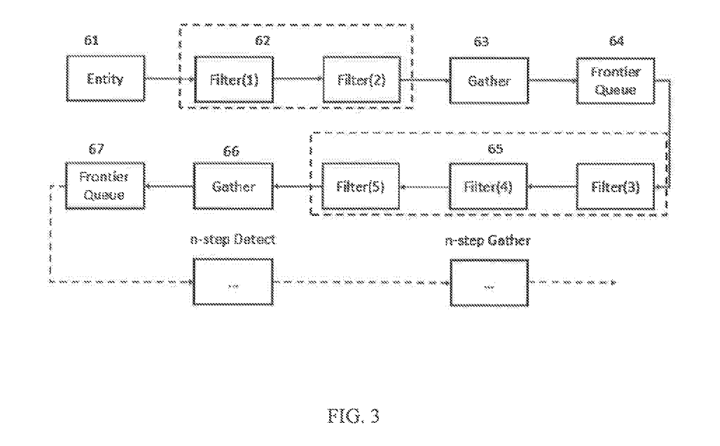

FIG. 3 depicts iteration of rich metadata in a GPU according to the present invention. The users, the jobs and the data files form plural entity nodes 61 of the initial iteration. The detecting module 43 performs a first-time detection 62 on the entity nodes 61. Preferably, in the present invention, there may be one filtering condition or plural filtering conditions in the detecting stage. The gathering module 44 performs a first-time gathering on the entity nodes 61 satisfying the filtering conditions to form a first frontier queue 64. When the iteration has not been completed, the data of the first frontier queue 64 is taken as the initial data for the next round of iteration. For example, the detecting module 43 takes the data of the first frontier queue 64 as the initial data for a second-time detection 65. The gathering module 44 performs a second-time gathering 66 on the entity nodes satisfying the second-time filtering conditions. After the gathering, the second frontier queue 67 is formed. The process is cycled until the iteration is completed. When the iteration has been completed, the gathering module 44 sends the final frontier queue data to the search engine 10 for traversal again, so as to get the final total result.

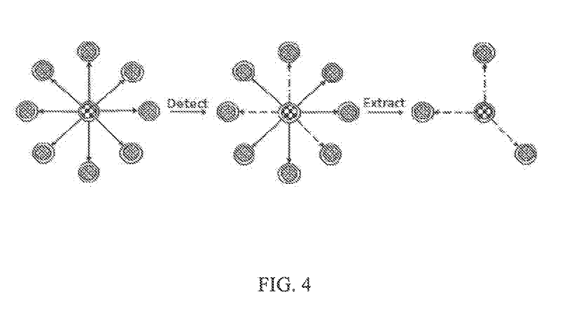

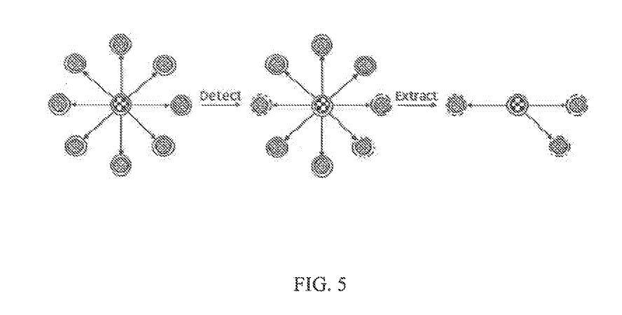

FIG. 4 and FIG. 5 show the operations on the property graph in the detecting stage and the gathering stage of the iteration process.

In the detecting stage, the filtering conditions may be about the properties of the vertexes, or may be about the properties of the edges. FIG. 4 depicts the detecting stage and the gathering stage working on the vertexes. FIG. 5 depicts the detecting stage and the gathering stage working on the edges. With every time of detecting and gathering in several times of iteration, the property graph becomes smaller and smaller until the final result comes out.

### Embodiment 2

The present embodiment is further improvement according to Embodiment 1, and the repeated description is omitted herein.

The present embodiment provides a GPU-based method for optimizing rich metadata management, wherein the method at least comprises:

S1: converting rich metadata information into traversal information and/or search information of a property graph, and providing at least one API (application programming interface) according to a traversal process and/or a search process;
S2: setting relationships among entity nodes in the property graph by mapping;
S3: activating a GPU thread group and allotting video memory blocks, so as to store the property graph in a GPU as a mixed graph; and
S4: activating a traversal program and performing detection and gathering on stored property arrays for iteration, and feeding back a result of the iteration to a search engine.

The method of the present embodiment is performed using the hardware as described in Embodiment 1. One skilled in the art would be rapidly aware of the composition of the hardware by referring to Embodiment 1.

Preferably, the step of converting rich metadata information into traversal information and/or search information of a property graph, and providing at least one API according to a traversal process and/or a search process comprises the following steps:

S11 involves unifying rich metadata into a unified property graph.
S12 involves when management of the rich metadata requires searching metadata, calling the search engine to provide at least one API interface, so as to transform management of rich metadata into traversal and search of the property graph.

The relationships among entity nodes in the property graph are set by mapping, which in particular means taking the users, the jobs and the data files in the rich metadata as entity nodes of the property graph, taking the relationships among the three types of entity nodes as edges of the property graph, and taking properties of the entity nodes and of the relationships as properties of the property graph, thereby converting all the rich metadata into a property graph.

A GPU thread group is activated and video memory blocks are allotted. Specifically, data transmission between the cache region and the video memory is such managed that caching and video-memory are optimized. The mapping process and the video-memory allotting process work together to convert a series of search operations for rich metadata management search into basic array operations of the traversal module, so as to perform practical operation on the property graph data in the memory. That means to store the rich metadata information as arrays. Preferably, the method further comprises: in the mapping process and the video memory allotting process, converting the operational steps of management search for the rich metadata into at least one array applicable to the traversal module, and conducting practical operation according to the property graph.

Preferably, the step of activating a traversal program and performing detection and gathering on stored property arrays for iteration, and feeding back a result of the iteration to a search engine comprises:

S41 involves storing the property graph in the GPU as a mixed graph. Preferably, the mixed graph corresponding to the property graph includes graph architectures and SOAs (service oriented architectures), in which the graph architectures are stored in a CSR (control and status register) format; and the SOAs are stored as property arrays.
S42 involves performs iteration and traversal on the property arrays by means of detection and gathering.

Preferably, the step of detecting the property arrays comprises: determining whether properties of architecture of the property arrays satisfy filtering conditions, in which different properties are filtered linearly, and multiple filters constitute a combined filter.

Preferably, the property arrays are gathered by: gathering the entity nodes that satisfy the filtering conditions as data sets to receive the iteration, and performing the iteration on the data sets so as to form a frontier queue, in which the data sets include vertex sets and/or edge sets.

Preferably, the method further comprises: when the iteration has not been completed, taking the data set of the frontier queue as initial data for the next round of iteration, and when the iteration has been completed, feeding back the frontier queue to the search engine.

For example, FIG. 3 depicts traversal of rich metadata in the GPU according to the present invention. Users, jobs and data files act as plural entity nodes 61 for the initial iteration. The detecting module 43 performs a first-time detecting 62 on the entity nodes 61. Preferably, there may be a filtering condition or plural filtering conditions in the detecting stage. The gathering module 44 performs a first-time gathering on the entity nodes 61 satisfying the filtering condition, so as to form a first frontier queue 64. When the iteration has not been completed, the data of the first frontier queue 64 is taken as the initial data for the next round of iteration. For example, the detecting module 43 takes the data of the first frontier queue 64 as the initial data for a second-time detecting 65. The gathering module 44 performs a second-time gathering 66 on the entity nodes satisfying the second-time filtering conditions. After the gathering, a second frontier queue 67 is formed. This process is cycled until the iteration is completed. After the iteration has been completed, the gathering module 44 sends the final frontier queue data to the search engine 10 for traversal again, so as to obtain the final total result.

While the above description has illustrated the present invention in detail, it is obvious to those skilled in the art that many modifications may be made without departing from the scope of the present invention and all such modifications are considered a part of the present disclosure. In view of the aforementioned discussion, relevant knowledge in the art and references or information that is referred to in conjunction with the prior art (all incorporated herein by reference), further description is deemed necessary. In addition, it is to be noted that every aspect and every part of any embodiment of the present invention may be combined or interchanged in a whole or partially. Also, people of ordinary skill in the art shall appreciate that the above description is only exemplificative, and is not intended to limit the present invention.

The above discussion has been provided for the purposes of exemplification and description of the present disclosure. This does not mean the present disclosure is limited to the forms disclosed in this specification. In the foregoing embodiments, for example, in order to simplify the objectives of the present disclosure, various features of the present disclosure are combined in one or more embodiments, configurations or aspects. The features in these embodiments, configurations or aspects may be combined with alternative embodiments, configurations or aspects other than those described previously. The disclosed method shall not be interpreted as reflecting the intention that the present disclosure requires more features than those expressively recited in each claim. Rather, as the following claims reflect, inventive aspects lie in less than all features of a single foregoing disclosed embodiment. Therefore, the following claims are herein incorporated into the embodiments, wherein each claim itself acts as a separate embodiment of the present disclosure.

Furthermore, while the description of the present disclosure comprises description to one or more embodiments, configurations or aspects and some variations and modifications, other variations, combinations and modifications are also within the scope of the present disclosure, for example within the scope of skills and knowledge of people in the relevant field, after understanding of the present disclosure. This application is intended to, to the extent where it is allowed, comprise rights to alternative embodiments, configurations or aspects, and rights to alternative, interchangeable and/or equivalent structures, functions, scopes or steps for the rights claimed, no matter whether such alternative, interchangeable and/or equivalent structures, functions, scopes or steps are disclosed herein, and is not intended to surrender any of the patentable subject matters to the public.

What is claimed is:

1. A graphic processing unit (GPU)-based system for optimizing rich metadata management, the system comprising:
a search engine configured to:
convert rich metadata information into at least one of traversal information and search information of a property graph: and
provide at least one application programming interface according to at least one of a traversal process and a search process;
a mapping module configured to set relationships among entity nodes in the property graph by mapping;
a management module configured to:
activate a GPU thread group;
allot video memory blocks; and
store the property graph in a GPU as a mixed graph, wherein the mixed graph corresponding to the property graph includes graph architectures and service oriented architectures, in which the graph architectures are stored in a control and status register format and the service oriented architectures are stored as property arrays; and
a traversal module configured to:
activate a traversal program;
perform iterative detection and gathering on stored property arrays; and
provide the result of the iteration to the search engine.

2. The system of claim 1, wherein the system further comprises a storage module configured to store the rich metadata information as arrays.

3. The system of claim 2, wherein:
the entity nodes of the property graph comprises at least one of a user, a job and a data file;
an edge of the property graph is a relationship between at least two entity nodes; and
properties in the property graph include properties of the entity nodes and properties of the relationships between the entity nodes.

4. The system of claim 3, wherein the traversal module is configured to detect the property arrays by determining whether properties of architecture of the property arrays satisfy filtering conditions, in which different properties are filtered linearly, and multiple filters constitute a combined filter.

5. The system of claim 4, wherein the traversal module is configured to gather the property arrays by:
gathering the entity nodes that satisfy the filtering conditions as data sets to receive the iteration; and
performing the iteration on the data sets to form a frontier queue, in which the data sets include at least one of a vertex set and an edge set.

6. The system of claim 5, wherein:
when the iteration has not been completed, the traversal module takes the data sets of the frontier queue as initial data for a next round of the iteration; and
when the iteration has been completed, the traversal module feeds back the frontier queue to the search engine.

7. The system of claim 6, wherein the mapping module and the management module work together in a complementary way to:
convert operational steps of management;
search for the rich metadata in at least one array applicable to the traversal module; and
conduct practical operation according to the property graph.

8. A graphic processing unit (GPU)-based method for optimizing rich metadata management, wherein the method comprises:
converting rich metadata information into at least one of traversal information and search information of a property graph;
providing at least one application programming interface according to at least one of a traversal process and a search process;
setting relationships among entity nodes in the property graph by mapping;
activating a GPU thread group;
allotting video memory blocks;
storing the property graph in a GPU as a mixed graph, wherein the mixed graph corresponding to the property graph includes graph architectures and service oriented architectures, in which the graph architectures are stored in a control and status register format and the service oriented architectures are stored as property arrays;
activating a traversal program;
performing detection and gathering on stored property arrays for iteration; and
providing a result of the iteration to a search engine.

9. The method of claim 8, wherein the method further comprises storing the rich metadata information as arrays.

10. The method of claim 9, wherein performing detection and gathering are jointly performed in the GPU in a convergent way.

11. The method of claim 10, wherein the traversal module detects the property arrays by determining whether properties of architecture of the property arrays satisfy filtering conditions, in which different properties are filtered linearly, and multiple filters constitute a combined filter.

12. The method of claim 11, wherein the traversal module gathers the property arrays by:
gathering the entity nodes that satisfy the filtering conditions as data sets to receive the iteration; and
performing the iteration on the data sets so as to form a frontier queue, in which the data sets include at least one of a vertex set and an edge set.

13. A graphic processing unit (GPU)-based device for optimizing rich metadata management, wherein the device comprises a central processing unit (CPU) processor and a GPU, wherein the CPU processor comprises a mapping module, a search engine and a management module, and the GPU comprises a traversal module and a storage module, wherein:
the mapping module is configured to convert rich metadata information into a property graph, wherein edges of the property graph are relationships among at least one of users, jobs and data files as entity nodes of the property graph, and wherein properties of the property graph include properties of at least one of the entity nodes and properties of the relationships among the three entity nodes;
the search engine is configured to convert the rich metadata into traversal search information of the property graph according to the search information of the rich metadata by calling an application programming interface;
the management module is configure to:
allot video memory of the storage module; and
send the traversal search information to the traversal module;
the traversal module is configured to:
detect and gather the traversal search information of the property graph by iteration; and
send frontier queue data formed through the iteration to the search engine; and
the storage module is configured to store the rich metadata information as arrays.
